(19) United States
(12) Patent Application Publication
(10) Pub. No.: US 2026/0222386 A1
(43) Pub. Date: Jul. 30, 2026

(54) NETWORK PACKET PROCESSING METHOD AND DEVICE

(71) Applicant: SENAO NETWORKS, INC., Taoyuan (TW)

(72) Inventors: MING-JEN HSU, Taoyuan (TW); Guan-Hong Lin, Taoyuan (TW); Wen-Hsiang Chen, Taoyuan (TW)

(21) Appl. No.: 19/221,662

(22) Filed: May 29, 2025

(30) Foreign Application Priority Data
Jan. 24, 2025 (TW) 114103609

(51) Int. Cl. H04L 9/40; H04L 61/2557

(52) U.S. Cl. CPC H04L 63/0236; H04L 61/2557; H04L 63/029; H04L 63/0435

(57) ABSTRACT

A method and device for network packet processing are provided. The network packet processing method comprises: receiving one or more packets respectively comprising a source address, a destination address, or both; and performing a packet processing decision comprising: determining whether the one or more source addresses, the one or more destination addresses, or both are within an address translation exclusion list; and in response to determining that the one or more source addresses, the one or more destination addresses, or both are within the address translation exclusion list, handling the one or more packets based on a tunneling protocol.

### CROSS-REFERENCE TO RELATED APPLICATIONS

This application claims priority to Taiwan Patent Application No. 114103609 filed on Jan. 24, 2025, which is hereby incorporated by reference in its entirety.

### FIELD OF INVENTION

The present invention relates to computer network architecture, and more particularly to a network packet processing method and device.

### BACKGROUND

Address translation (e.g., network address translation (NAT)) maps an IP address space to another address space by modifying the network address information in the IP header of a network packet as it is transmitted through a traffic routing device. One Internet-routable IP address of an address translation gateway (hardware or software) is available for the entire private network. Address translation can be used to reduce address overlap when hosts on different networks with the same IP address space attempt to reach the same destination host. Additionally, in client-server applications, where a load balancer forwards client requests to a cluster of server computers to manage the workload of each server, address translation can be used to map the representative IP address of a server cluster to the specific host that services the request.

Tunneling protocols allow data to move from one network to another, such as sending private network traffic over a public network, or carrying a specific network protocol over an incompatible network through a process called encapsulation. Other important uses include providing corporate network access to remote users whose physical network addresses are not part of the corporate network, ensuring network connection continuity for mobile devices, and achieving data transmission security in mobile networks. As a representative tunneling protocol, Internet Protocol Security (IPsec) functions to establish mutual authentication between agents at the beginning of a session and negotiate encryption keys used during the session. It also supports network-level peer authentication, data source authentication, data integrity, data confidentiality (encryption), and replay attack protection. A Virtual Private Network (VPN) is based on a tunneling protocol like IPsec, Layer 2 Tunneling Protocol (L2TP), or Secure Socket Tunneling Protocol (SSTP) that extends access to a private network to users who cannot access it directly. However, existing routing software such as VPP and TNSR usually perform address translation before tunneling, which can easily cause conflicts between NAT and VPN policy routing. For example, packets that should be authenticated and encrypted by IPsec may miss authentication and encryption due to redundant address translation.

### SUMMARY

The objective of the present invention is to introduce an evaluation mechanism to resolve conflicts between NAT and VPN policy routing, thereby enhancing the architecture of existing routing software.

One embodiment of the present invention is directed to a network packet processing method, comprising: receiving one or more packets respectively comprising a source address, a destination address, or both; and performing a packet processing decision comprising: determining whether the one or more source addresses, the one or more destination addresses, or both are within an address translation exclusion list; and in response to determining that the one or more source addresses, the one or more destination addresses, or both are within the address translation exclusion list, handling the one or more packets based on a tunneling protocol.

In some implementations, receiving the one or more packets is performed under VPP (Vector Packet Processing) architecture.

In some implementations, performing the packet processing decision further comprises: in response to determining that neither the one or more source addresses nor the one or more destination addresses is within the address translation exclusion list, performing address translation to the one or more source addresses, the one or more destination addresses, or both.

In some implementations, the tunneling protocol is used to establish a virtual private network (VPN).

In some implementations, the tunneling protocol is Internet Protocol Security (IPsec).

In some implementations, handling the one or more packets comprises: determining whether to encrypt or decrypt the one or more packets based on a security policy list according to the one or more source addresses, the one or more destination addresses, or both.

Another embodiment of the present invention is directed to a network packet processing device comprising a processor and a memory. The memory stores code, when executed, causing the processor to: receive one or more packets respectively comprising a source address, a destination address, or both; and perform a packet processing decision comprising: determining whether the one or more source addresses, the one or more destination addresses, or both are within an address translation exclusion list; and in response to determining that the one or more source addresses, the one or more destination addresses, or both are within the address translation exclusion list, handling the one or more packets based on a tunneling protocol.

In some implementations, receiving the one or more packets is performed under VPP (Vector Packet Processing) architecture.

In some implementations, the code causing the processor to perform the packet processing decision further comprises code causing the processor to: in response to determining that neither the one or more source addresses nor the one or more destination addresses is within the address translation exclusion list, perform address translation to the one or more source addresses, the one or more destination addresses, or both.

In some implementations, the tunneling protocol is used to establish a virtual private network (VPN).

In some implementations, the tunneling protocol is Internet Protocol security (IPsec).

In some implementations, the code causing the processor to handle the one or more packets based on a tunneling protocol further comprises code causing the processor to: determine whether to encrypt or decrypt the one or more packets based on a security policy list according to the one or more source addresses, the one or more destination addresses, or both.

### BRIEF DESCRIPTION OF THE DRAWINGS

FIG. 1 is a network structure schematic diagram according to an embodiment of the present invention.

FIG. 2A is a network packet processing method flowchart according to an embodiment of the present invention.

FIG. 2B is an address translation exclusion list according to an embodiment of the present invention.

FIG. 3 is a tunneling process flowchart according to an embodiment of the present invention.

FIG. 4 is a tunneling protocol security policy list according to an embodiment of the present invention.

### DETAILED DESCRIPTION

Features of the present invention are set forth below in connection with the appended drawings, for the purpose of providing a thorough view of various concepts while not intended to represent the only configurations in which the concepts described herein may be practiced. One of ordinary skill in the art may, after understanding embodiments of the present invention, change and modify the techniques taught herein without departing from the spirit and scope of the present invention.

The terms “include”, “comprises”, “have”, “contain”, etc. used herein are open-ended terms, meaning including but not limited to.

The term “and/or” used herein includes any or all combinations of the items described.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning consistent with their meaning in the context of the relevant art and the present invention, and will not be interpreted in an idealized or overly formal sense unless expressly so defined herein.

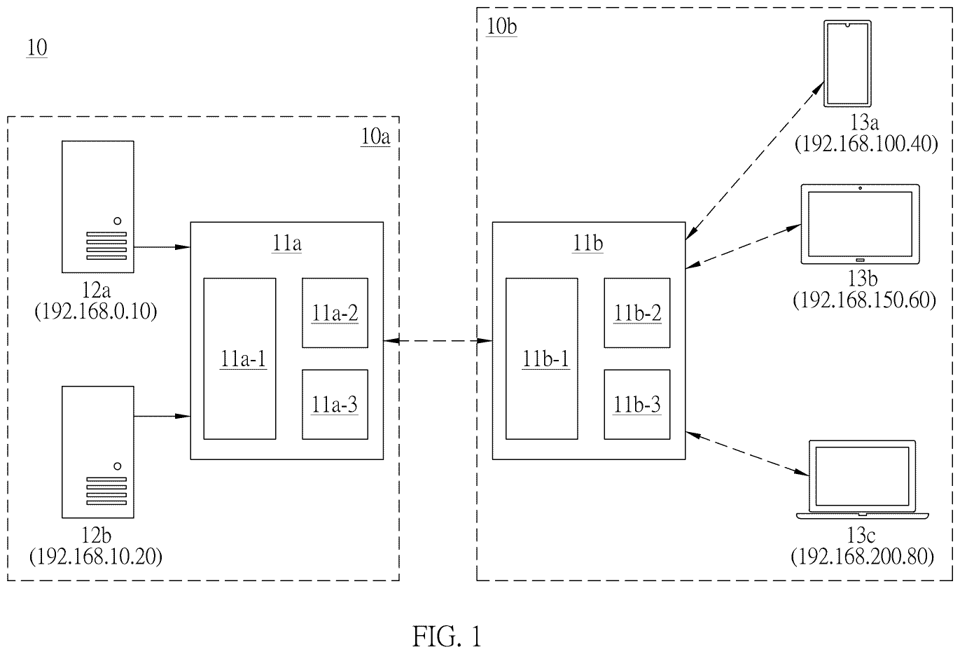

FIG. 1 is a network structure schematic diagram according to an embodiment of the present invention. As shown in FIG. 1, a network 10 includes routers 11a and 11b. The router 11a communicatively connects servers 12a and 12b as well as allocates virtual network addresses to constitute a private network 10a; the router 11b communicatively connects user terminals 13a, 13b and 13c as well as allocates virtual network addresses to constitute a private network 10b. The routers 11a and 11b respectively comprise processors 11a-1 and 11b-1, memories 11a-2 and 11b-2 as well as network interfaces 11a-3 and 11b-3, wherein the memories 11a-2 and 11b-2 store code causing the processors 11a-1 and 11b-1 to perform the network packet processing method described below via the network interfaces 11a-3 and 11b-3.

The private network 10a may be Ethernet, InfiniBand or Fibre Channel; the private network 10b may be a wireless local area network (compliant with IEEE standards such as Wi-Fi, etc.) or cellular network (e.g., those compliant with 3GPP 4G LTE, 5G NR or future 6G standards), but the present invention is not limited thereto. For example, the user terminals 13a and 13b may share a physical network address of the router 11b via NAT, in order to use services like website browsing, file sharing or media streaming provided by the server 12a; the user terminal 13c may use corporate network access provided by the server 12b through the routers 11a and 11b via VPN.

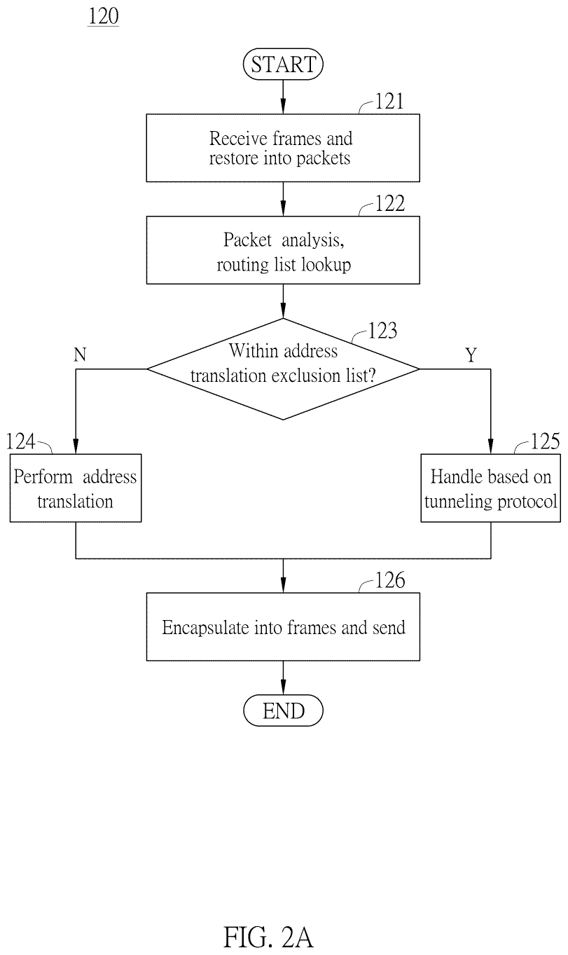

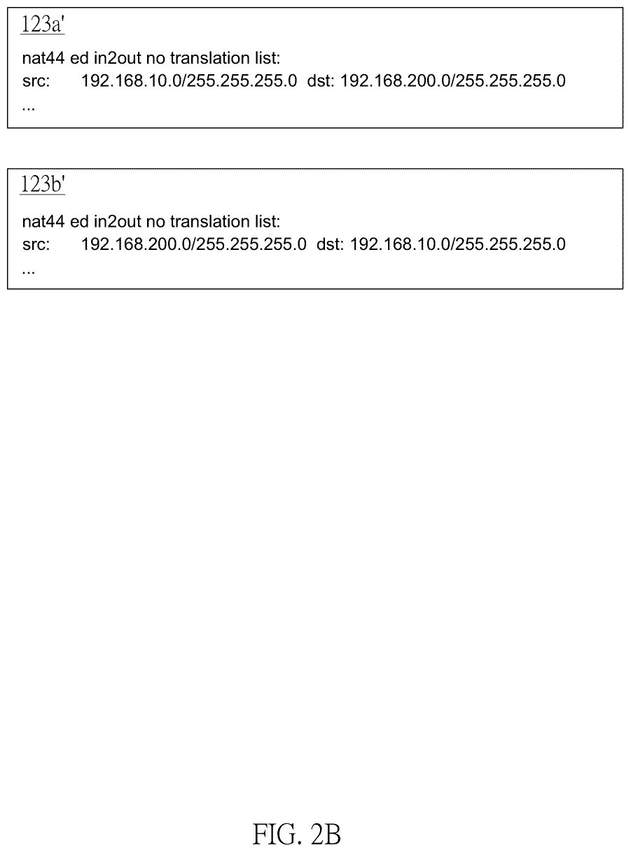

FIG. 2A is a network packet processing method flowchart according to an embodiment of the present invention. As shown in FIG. 2A and taking VPP architecture as an example, the packet processing method 120 starts from node 121, where the router 11a or the router 11b receives a plurality of (link layer) frames from servers, other routers or user terminals and restores them into one or more (network layer) packets, with operations like learning forwarding rule(s), determining target port(s), etc. The one or more packets respectively comprise a source address, a destination address, or both. In one aspect, the source address, the destination address, or both may be included within a header of the packet. Subsequently at node 122, the packets are received, and operations like analysis and routing list lookup are performed thereon. Then, an address translation exclusion list is looked up at node 123 to determine whether the source addresses, the destination addresses, or both of the packets are within the address translation exclusion list, thereby judging whether address translation is needed for the packets. If neither a source address nor a destination address is within the address translation exclusion list, the corresponding packet will be forwarded to node 124 where address translation is performed to the source address, the destination address, or both. If a source address, a destination address, or both are within the address translation exclusion list, address translation is needed for the corresponding packet, and the corresponding packet will be forwarded to node 125 to be handled based on a tunneling protocol like IPsec, L2TP or SSTP. For example, one or more packets sent from the user terminal 13c to the server 12b comprise the source address 192.168.200.80 and the destination address 192.168.10.20. According to the address translation exclusion list 123b′ shown in FIG. 2B, which contains “src: 192.168.200.0” as well as subnet mask “255.255.255.0”, the node 123 of the router 11b may determine that the source addresses of the packets are within the address translation exclusion list 123b′. On the other hand, one or more packets sent from the server 12b to the user terminal 13c comprise source address 192.168.10.20 and destination address 192.168.200.80. According to the address translation exclusion list 123a′, which contains “src: 192.168.10.0” as well as subnet mask “255.255.255.0”, the node 123 of the router 11a may determine that the source addresses of the packets are within the address translation exclusion list 123a′. Finally, the nodes 124 and 125 forward the handled packets to node 126 for encapsulating into frames and sending to servers, other routers or user terminals.

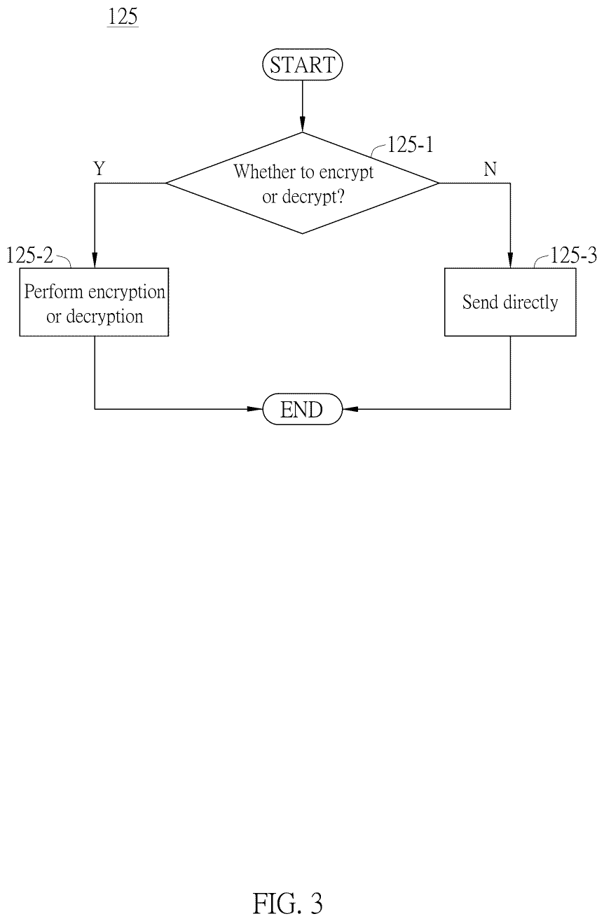

FIG. 3 is a tunneling process flowchart, namely more detailed steps inside the node 125, according to an embodiment of the present invention. As shown in FIG. 3, a sub-node 125-1 determines whether to encrypt or decrypt packets based on a security policy list (e.g., security policy database (SPD) rule in VPP architecture). If determined to be encrypted or decrypted, the corresponding packets will be forwarded to sub-node 125-2 for encryption or decryption; otherwise, the corresponding packets will be forwarded to sub-node 125-3 and sent directly by the node 126.

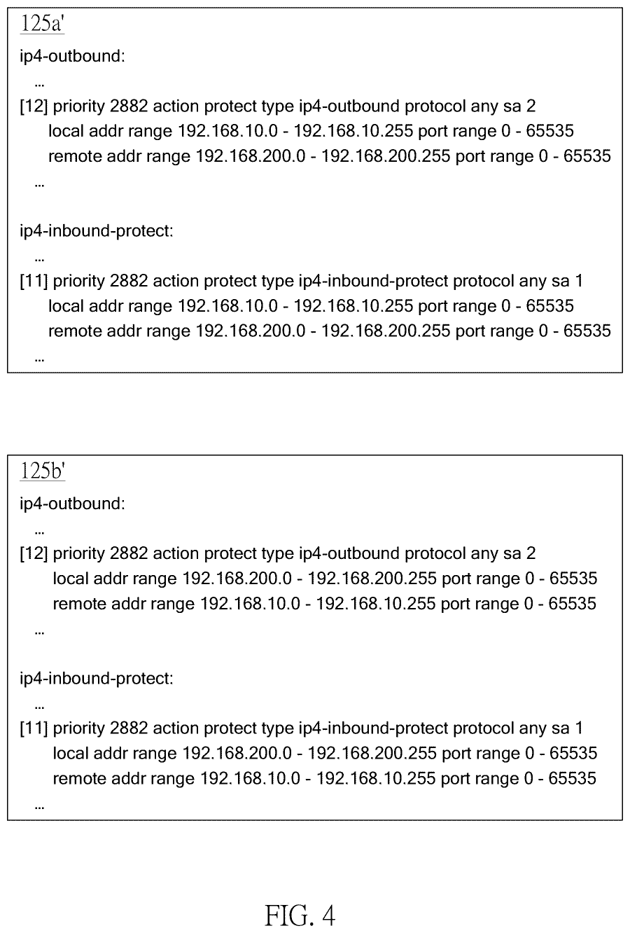

FIG. 4 is a tunneling protocol security policy list according to an embodiment of the present invention. It is known from FIG. 1 that one or more packets sent from the user terminal 13c to the server 12b comprise the source address 192.168.200.80 and the destination address 192.168.10.20. When the node 123 of the router 11b determines that the source addresses of the packets are within the address translation exclusion list 123b′, address translation is not performed for the packets. Subsequently, the node 125 determines whether to encrypt the packets based on policies included in the ‘ip4-outbound’ rule in the security policy list 125b′. After the router 11a receives the packets, its node 123 determines that the destination addresses of the packets are within the address translation exclusion list 123a′. Subsequently, the node 125 determines whether to decrypt the packets based on policies included in the ‘ip4-inbound-protect’ rule in the security policy list 125a′. In some instances, the source addresses of the packets may not be within the security policy lists, e.g., address of the user terminal 13c may be 192.168.205.80 or not loaded in the packets, but as long as the destination addresses are still within the security policy lists, the packets may also receive encryption and decryption treatments. In some instances, contents of the address translation exclusion lists may be recorded according to the security policy lists. For example, the router 11a may record “src: 192.168.10.0” and “dst: 192.168.200.0” into the address translation exclusion list 123a′ according to the ‘ip 4-outbound’ rule in the security policy list 125a′. The recording may be done, for example, by the router reading the rules in the security policy lists and copying them to the address translation exclusion lists, or by the administrator setting up the address translation exclusion lists according to the security policy lists, but the present invention is not limited thereto.

In analogy, one or more packets sent from the server 12b to the user terminal 13c, comprising source address 192.168.10.20 and destination address 192.168.200.80, may also have VPN policy routing completed without redundant address translation. In some instances, the source addresses of the packets may not be within the security policy lists, e.g., address of the server 12b may be 192.168.15.20 or not loaded in the packets, but as long as the destination addresses are still within the security policy lists, the packets may also receive encryption and decryption treatments.

Although the present invention has been disclosed as above by the embodiments, it is not intended to limit the present invention. One of ordinary skill in the art can make various changes and modifications without departing from the spirit and scope of the present invention. Accordingly, the scope of the present invention is to be accorded the broadest scope consistent with the appended claims rather than the foregoing description and the exemplary embodiments described therein.

What is claimed is:

1. A network packet processing method, comprising:
receiving one or more packets respectively comprising a source address, a destination address, or both; and
performing a packet processing decision comprising:
determining whether the one or more source addresses, the one or more destination addresses, or both are within an address translation exclusion list; and
in response to determining that the one or more source addresses, the one or more destination addresses, or both are within the address translation exclusion list, handling the one or more packets based on a tunneling protocol.

2. The network packet processing method of claim 1, wherein receiving the one or more packets is performed under VPP (Vector Packet Processing) architecture.

3. The network packet processing method of claim 1, wherein performing the packet processing decision further comprises:
in response to determining that neither the one or more source addresses nor the one or more destination addresses is within the address translation exclusion list, performing address translation to the one or more source addresses, the one or more destination addresses, or both.

4. The network packet processing method of claim 1, wherein the tunneling protocol used to establish a virtual private network (VPN).

5. The network packet processing method of claim 1, wherein the tunneling protocol is Internet Protocol Security (IPsec).

6. The network packet processing method of claim 1, wherein handling the one or more packets comprises:
determining whether to encrypt or decrypt the one or more packets based on a security policy list according to the one or more source addresses, the one or more destination addresses, or both.

7. A network packet processing device, comprising:
a processor; and
a memory storing code, when executed, causing the processor to:
receive one or more packets respectively comprising a source address, a destination address, or both; and
perform a packet processing decision comprising:
determining whether the one or more source addresses, the one or more destination addresses, or both are within an address translation exclusion list; and
in response to determining that the one or more source addresses, the one or more destination addresses, or both are within the address translation exclusion list, handling the one or more packets based on a tunneling protocol.

8. The network packet processing device of claim 7, wherein receiving the one or more packets is performed under VPP (Vector Packet Processing) architecture.

9. The network packet processing device of claim 7, wherein the code causing the processor to perform the packet processing decision further comprises:
code causing the processor to: in response to determining that neither the one or more source addresses nor the one or more destination addresses is within the address translation exclusion list, perform address translation to the one or more source addresses, the one or more destination addresses, or both.

10. The network packet processing device of claim 7, wherein the tunneling protocol is used to establish a virtual private network (VPN).

11. The network packet processing device of claim 7, wherein the tunneling protocol is Internet Protocol Security (IPsec).

12. The network packet processing device of claim 7, wherein the code causing the processor to handle the one or more packets based on a tunneling protocol further comprises:
code causing the processor to: determine whether to encrypt or decrypt the one or more packets based on a security policy list according to the one or more source addresses, the one or more destination addresses, or both.
